(19) United States
(12) Patent Application Publication
(10) Pub. No.: US 2003/0016727 A1
(43) Pub. Date: Jan. 23, 2003

(54) Method of and apparatus for measuring and controlling substrate holder temperature using ultrasonic tomography

(75) Inventors: William Jones, Phoenix, AZ (US); Michael Grapperhaus, Gilbert, AZ (US); Andrej Mitrovic, Phoenix, AZ (US); Robert Jackson, Gilbert, AZ (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKYO ELECTRON LIMITED, Tokyo (JP)

(21) Appl. No.: 10/183,360

(22) Filed: Jun. 28, 2002

Related U.S. Application Data
(60) Provisional application No. 60/301,433, filed on Jun. 29, 2001.

(51) Int. Cl. G01K 11/22

(52) U.S. Cl. 374/117

(57) ABSTRACT

Ultrasonic transducers and tomographic techniques determine the temperature of a semiconductor substrate holder at all points on the substrate holder, thereby allowing comprehensive real-time control of the temperature of the substrate holder during a process, such as a semiconductor wafer etching process. An apparatus for measuring temperatures of respective portions of a substrate holder that supports a substrate (e.g., a semiconductor wafer) on which a process (e.g., an etching process) is carried out, and for controlling the temperatures of the respective portions in response to the measured temperatures, includes: an arrangement of at least one ultrasonic transducer arranged and configured to transmit ultrasonic energy through the substrate holder, and a data processor configured to calculate, during the process, the temperatures of the respective portions of the substrate holder based on respective propagation time delays of the ultrasonic energy through the respective portions.

### CROSS-REFERENCE TO RELATED APPLICATIONS

This application claims priority to U.S. Provisional Application Ser. No. 60/301,433, filed on Jun. 29, 2001, the entire contents of which are incorporated herein by reference.

### BACKGROUND OF THE INVENTION

1. Field of the Invention

The present invention relates to methods and apparatus for measuring and controlling the temperature of substrate holders that support substrates during processes such as semiconductor etching processes.

2. Description of the Background

Plasma or dry etching of silicon wafers to transfer a pattern of integrated circuits from photolithographic masks to the silicon wafers have become standard methods in the industry. In conventional dry etchers, the silicon wafer being etched is ordinarily held in close proximity to the wafer chuck by electrostatic force. This system is quite effective in holding the wafer securely to the chuck during processing, permitting good heat transfer and good electrical connectivity between the wafer and the other components in the etching system.

It is important to measure the temperature of the wafer chuck during the process cycle. Merely ensuring good contact between the wafer and wafer chuck is insufficient if the temperature and the temperature uniformity of the chuck is not adequately controlled.

Methods of controlling the temperature of wafer chucks include the use of thermocouples, infrared pyrometry, and liquid crystals. Thermocouples embedded in the wafer chuck are widely used for the temperature control of the wafer chuck, as are infrared emission optical pyrometry, and the use of materials such as liquid crystals that fluoresce at desired temperatures. However, these all have the shortcoming of either measuring the temperature at one point, or at most a few discrete points, around the wafer chuck.

Research publications by K. Saraswat and his group at Stanford University (for example, Mat. Res. Soc. Symp. Proc. Vol. 387, pg. 35, 1995, Materials Research Society) have disclosed the utilization of the propagation velocity of Lamb ultrasonic waves in silicon wafers to measure the temperature of the wafers. U.S. Pat No. 6,019,000 (Stanke et al.) and U.S. Pat. No. 5,271,274 (Khuri-Yakub et al.) disclose the use of the propagation velocity of ultrasonic waves for the measurement of the thickness of films deposited on substrates such as silicon, discuss the temperature effects on the velocity of the waves in solids, and describe means for compensating for these temperature effects.

However, it is not believed that the art has recognized a way of (1) measuring a temperature at all points on a wafer chuck simultaneously, especially during processing, or (2) allowing responsive and comprehensive control of wafer chuck temperature based on the temperature measurements. It is to meet these needs, among others, that the present invention is directed.

### SUMMARY OF THE INVENTION

The present invention provides for use of ultrasonic transducers together with tomographic techniques to determine the temperature of a substrate holder (e.g., a chuck or an electrotatic chuck for a substrate) at all points on the substrate holder, thereby allowing comprehensive control of the temperature of the substrate holder during processing. As used herein, “substrate” is a general term for a processed workpiece, e.g., a semiconductor wafer or liquid crystal display panel.

The invention provides an apparatus for measuring temperatures of respective portions of a substrate holder that supports a substrate on which a process is carried out. The apparatus comprises an arrangement of at least one ultrasonic transducer arranged and configured to transmit ultrasonic energy through the substrate holder, and a data processor configured to calculate, during the process, the temperatures of the respective portions of the substrate holder based on respective propagation time delays of the ultrasonic energy through the respective portions.

Similarly, the invention also provides a method for measuring temperatures of respective portions of a substrate holder that supports a substrate on which a process is carried out, the method comprising transmitting ultrasonic energy through the substrate holder using an arrangement of at least one ultrasonic transducer, and calculating, during the process, the temperatures of the respective portions of the substrate holder based on respective propagation time delays of the ultrasonic energy through the respective portions.

Moreover, the invention provides an apparatus for measuring temperatures of respective portions of a substrate holder that supports a substrate on which a process is carried out, and for controlling the temperatures of the respective portions in response to the measured temperatures. The apparatus comprises an arrangement of at least one ultrasonic transducer arranged and configured to transmit ultrasonic energy through the substrate holder, and a data processor configured to calculate, during the process, the temperatures of the respective portions of the substrate holder based on respective propagation time delays of the ultrasonic energy through the respective portions. The data processor is further configured to communicate, during the process, at least one of (1) a correction signal to a heater controller, (2) a warning signal to a display/alarm device and (3) an error signal to a process controller, if a calculated temperature exceeds a predetermined temperature limit.

Similarly, the invention also provides a method for measuring temperatures of respective portions of a substrate holder that supports a substrate on which a process is carried out, and for controlling the temperatures of the respective portions in response to the measured temperatures. The method comprises transmitting ultrasonic energy through the substrate holder using an arrangement of at least one ultrasonic transducer, calculating, during the process, the temperatures of the respective portions of the substrate holder based on respective propagation time delays of the ultrasonic energy through the respective portions, and communicating, during the process, at least one of (1) a correction signal to a heater controller, (2) a warning signal to a display/alarm device and (3) an error signal to a process controller, if a calculated temperature exceeds a predetermined temperature limit.

In particular preferred embodiments, the data processor may be further configured to use tomographic techniques to construct a temperature map of the substrate holder based collectively on the calculated temperatures of the portions of the substrate holder.

In addition, the invention provides a method for measuring respective portions of a substrate holder that supports a substrate on which a process is carried out to ensure that respective elements within the substrate holder are operating correctly. The method comprises: transmitting ultrasonic energy through the substrate holder using an arrangement of at least one ultrasonic transducer; calculating, during the process, the respective propagation time delays of the ultrasonic energy through the respective portions; analyzing the respective reflection signal amplitudes; and communicating, during the process, at least one of (1) an error signal to a process controller and (2) a warning signal to a display/alarm device, if a calculated propagation time delay exceeds a predetermined limit.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1A illustrates a portion of a temperature sensing apparatus according to a simplified embodiment of the present invention;

FIG. 1B illustrates an exemplary configuration of a substrate holder temperature sensing and control apparatus according to a preferred embodiment of the present invention;

FIG. 1C illustrates a first configuration of transducer emission and pickup across a plane of the substrate holder parallel to a plane of the surface of the wafer;

FIG. 1D illustrates a second configuration of transducer emission and pickup across a plane of the substrate holder parallel to a plane of the surface of the wafer;

FIG. 1E illustrates a first configuration of transducer emission and pickup inside the substrate holder in a plane perpendicular to a plane of the surface of the wafer;

FIGS. 2A and 2B illustrate ultrasonic waveforms received by transducers, illustrating the dependence of propagation time on the temperature of “slices” (portions) of the substrate holder through which the ultrasonic waves have traveled;

FIG. 3 illustrates the dependence of ultrasonic wave velocity on the temperature of portions of the substrate holder through which the ultrasonic waves have traveled;

FIG. 4 illustrates an exemplary configuration of a substrate holder temperature sensing and control apparatus according to another embodiment of the present invention;

FIG. 5A is a flow chart illustrating a substrate holder temperature sensing and control method according to a first embodiment of the present invention; FIG. 5B is a flow chart illustrating another embodiment of the inventive method, that employs tomographic techniques to sense and control substrate holder temperature using a comprehensive temperature map of the substrate holder; and

FIG. 6 is a schematic illustration of an exemplary computer for calculating the temperature and/or tomographic information according to the present invention.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The velocity of ultrasonic waves through material is a function of the temperature of the material. The inventors have recognized that the time for the propagation of an ultrasonic wave for a known distance may be used to interpret the temperature of the material in a substrate holder (e.g., a chuck, an electrostatic chuck or a support for holding a semiconductor wafer, a liquid crystal display panel or another material to be processed).

Tomography has become a useful instrument for generating an image or cross section of an opaque solid object. It has been widely utilized in medical applications such as CAT scans and ultrasonic mapping. However, it is not believed to have been applied to measurement and control of temperature throughout a substrate holder, especially for measurement and control during processing.

Briefly, according to the invention, ultrasonic tomography is utilized to obtain a map of the temperature of a substrate holder by applying an array of ultrasonic transducers around the periphery of the substrate holder. The length of time for the ultrasonic wave to transit the substrate holder (the propagation time) is measured and used to conclude the temperature of that slice of the substrate holder. By applying the tomographic interpretation of the temperatures of each of the transducers, a map of the temperature of the entire substrate holder is generated during the process.

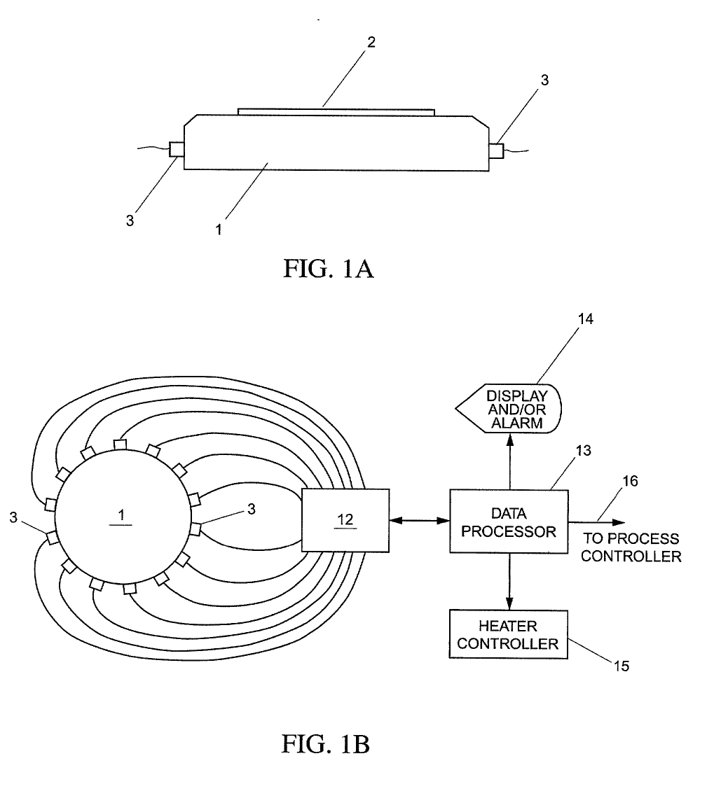

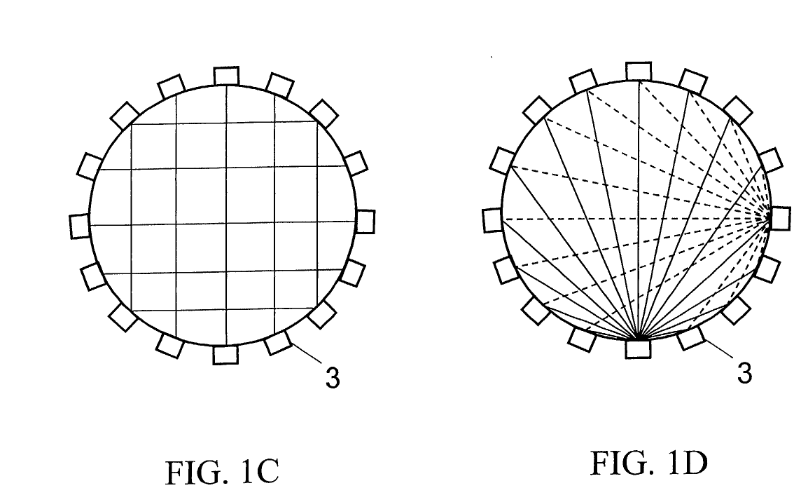

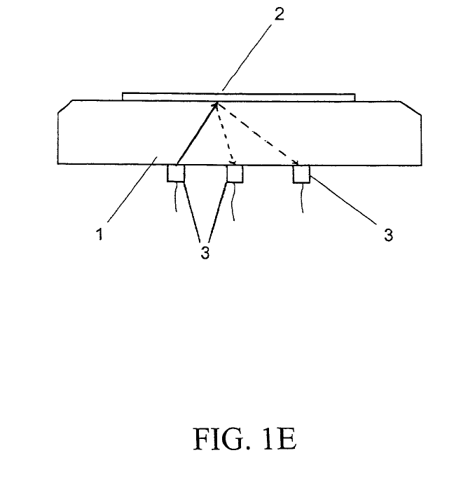

FIG. 1A illustrates a simplified embodiment of the present invention. A substrate holder 1 is housed in a plasma processing chamber (not shown) and connected to an RF power source (not shown) that provides the energy to produce the plasma for processing a substrate 2. A plurality of ultrasonic transducers 3 is provided around the periphery of the substrate holder 1. Ultrasonic transducers 3 can be either piezoelectric or electro-mechanical/acoustic transducers (EMAT). Ultrasonic transducers 3 can operate as transceivers capable of transmitting and receiving ultrasonic energy.

In the simplified embodiment shown in FIG. 1A, the time that is required for an ultrasonic wave to transit the substrate holder from one transducer to at least one other transducer is used to interpret the temperature of the substrate holder.

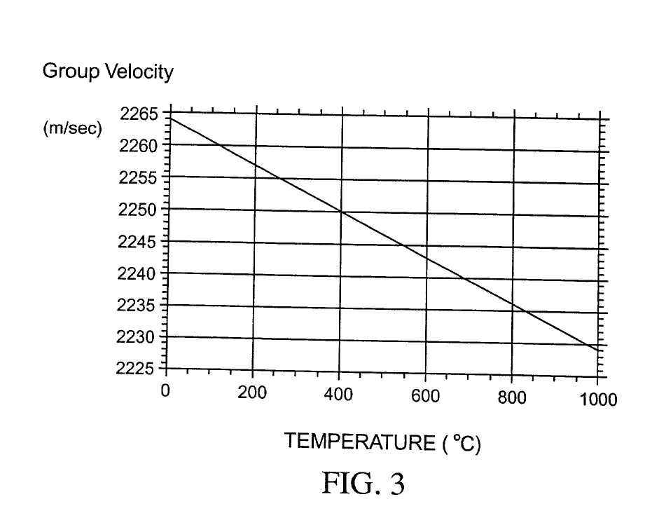

In the illustrated embodiment shown in FIG. 1B, ultrasonic transducers 3 are arranged in a substantially uniform pattern around the periphery of substrate holder 1. Many chucks (e.g., electrostatic wafer chucks) include a multiplicity of passageways machined into them for heating, cooling, gas introduction and other purposes, and the propagation patterns may be considerably more complex than described above. Thus, because of the complexity of some the electrostatic wafer chucks in use, it is important to mount the ultrasonic transducers in suitable locations, to minimize the effects of structures that would interfere with the ultrasonic waves. Also, by listening for waves only during a time window that brackets times during which ultrasonic waves are expected (based on a corresponding range of temperatures derived from FIG. 3), the effects of echoes from interfering structures can be minimized or eliminated.

A transducer of the plurality of transducers 3 launches an ultrasonic wave, and at least one of the plurality of transducers 3 directly “across” the substrate from the transmitting transducer receives an ultrasonic signal. The process is then repeated for the remaining transducers 3 that have not yet transmitted. In the arrangement, shown schematically in FIG. 1C, a number of transducer pairs can be established where a transducer pair comprises a transmitter and a receiver. The temperature of “slices” (portions) of the substrate holder disposed between the transducers of respective transducer pairs is determined. This temperature measurement allows a map of temperature as a function of physical location to be constructed. In a preferred embodiment, a plurality of ultrasonic transducer pairs are used to determine a map of the temperature of various slices on the substrate holder during the process. This map in turn allows comprehensive spatial control of the temperature of the substrate holder 1. It should be understood that transducers other than those directly across from a transmitting transducer can also receive the transmitted signal. Also, the same transducer 3 may either (1) transmit multiple times (once to each receiver “across” from it) or (2) transmit at least once and have plural receivers receive the same transmission.

According to an alternate embodiment, ultrasonic waves from a plurality of transmitters are received by a plurality of receivers. This is shown schematically in FIG. 1D for two transmitters and a plurality of receivers. The temperature of “slices” of the substrate holder disposed between the transmitters and the receivers is determined. This temperature measurement allows a map of temperature as a function of physical location to be constructed using tomographic calculation methods.

According to an alternate embodiment, a plurality of transmitters simultaneously transmit ultrasonic waves, where each wave comprises a transmitter-specific signal frequency. The ultrasonic signals that arrive at the receivers are separated into the transmitted signal frequencies using signal processing that is well known in the art.

For further details, the principles of tomography are described in The physical basis of computed tomogaphy (Marshall et al., Warren H, Green, Inc., St. Louis, Mo.) and Process tomography (Williams & Beck, Butterworth Heinemann, 1995.), and both are incorporated herein by reference in their entirety.

Referring more specifically to FIG. 1B, the plurality of transducers are shown arranged at substantially regular intervals around the periphery of the substrate holder 1. In the illustrated exemplary embodiment to which the scope of the invention should not be limited, some of the transducers are located directly across from each other (i.e., at diametrically opposite sides of the substrate holder).

Transducers 3 are coupled to transducer controller 12. Transducer controller 12 determines which transducers 3 to use to as transmitters and which transducers 3 to use as receivers. Transducer controller 12 comprises multiplexer and demultiplexer elements (not shown). Transducer controller 12 also comprises frequency generating elements (not shown).

Transducer controller 12, which can be implemented as a conventional microcontroller or digital signal processor, ensures that transducers 3 are active during their respective transmit times and receive times. For example, a sequential ordering scheme can be used to ensure that ultrasonic energy from one transmitter does not interfere with the ultrasonic energy from another transmitter.

In an alternative embodiment, as shown in FIG. 1E, one or more ultrasonic transducers that can operate as transceivers, capable of transmitting and receiving ultrasonic energy, are placed on the backside of the substrate holder. The temperature of the substrate holder is determined by observing reflection patterns of the ultrasonic waves from interfaces in the substrate holder. For example, an observed reflection can originate from the interface between the substrate holder and the overlying wafer or from interfaces inside the substrate holder.

Transducer controller 12 calculates information about the received waveforms, such as propagation time for a selected transducer pair, and forwards the information to a data processor 13. Data processor 13 can be implemented as a general purpose computer, for example.

In a preferred embodiment, data processor 13 performs the higher-level functions of computing velocity and temperature, based on the propagation times determined by the transducer controller. If a computed temperature measurement strays beyond an allowed parameter (determined beforehand for each particular substrate holder implementation), data processor 13 sends a message to heater controller 15, which can adjust heating elements accordingly. The heater controller can be coupled to resistive heating elements, thermoelectric devices and/or a heat exchanger in communication with fluid channels through which heated or cooled fluid can circulate.

In the event that a computed temperature violates a predetermined temperature limit at which the desired processing (e.g., etching) should not continue at all, data processor 13 sends a message on path 16 to a process controller (e.g., etch process controller, not shown), warning that the process should be interrupted. The process controller can then take appropriate action, as it may be programmed, such as halting the process. Additionally or alternatively, the data processor 13 can send a warning message to an operator via an output element 14, which can comprise a conventional display and/or audible warning (alarm) device.

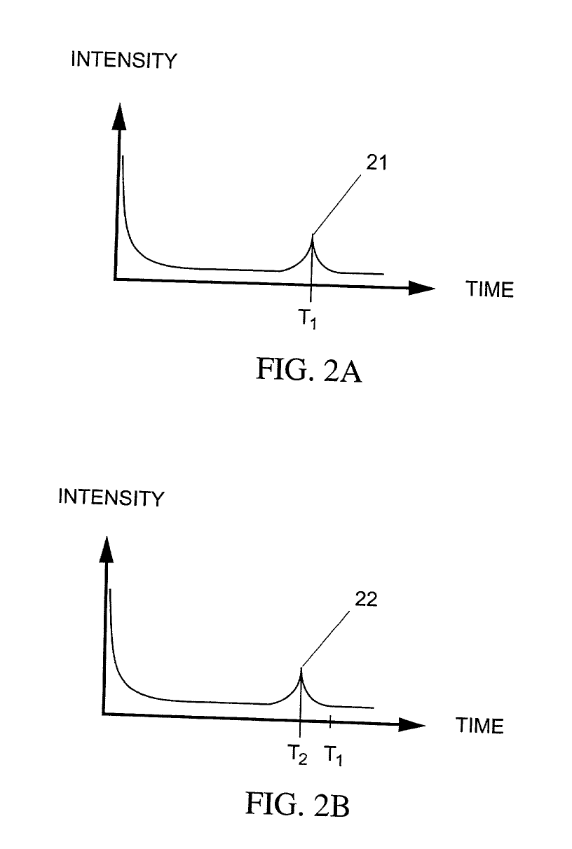

For example, the received data can be in the form of a waveform of ultrasonic energy intensity as a function of time, indicated in FIGS. 2A, 2B. Generally, the received data is more complex, and multiple peaks are present.

In FIG. 2A, the time for the wave to transit the substrate holder at a first temperature is shown as a peak 21 occurring at a time T₁. FIG. 2B shows the transit time at a second temperature as a peak 22 at time T₂. Time T₁ is different than time T₂ due to the difference in temperature along the slice traveled by the ultrasonic wave. Thus, if the arrival time peak changes from T₁ to T₂, this is an indication that the temperature of the substrate holder has changed. Such a change may indicate that the substrate has reached the appropriate temperature for processing or that corrective action may need to be taken.

FIG. 3 shows the velocity of ultrasonic waves in a given medium as a function of temperature. The curve shows a linear relationship, in which increasing temperature results in a reduced group velocity of the ultrasonic waves through the substrate holder. For example, using the basic formula velocity=distance/time with the known propagation distance for a particular portion of the substrate holder and the measured propagation time, the velocity of an ultrasonic wave in the portion of the substrate holder is determined. Finally, utilizing the curve in FIG. 3, the temperature of that portion of the substrate holder is determined.

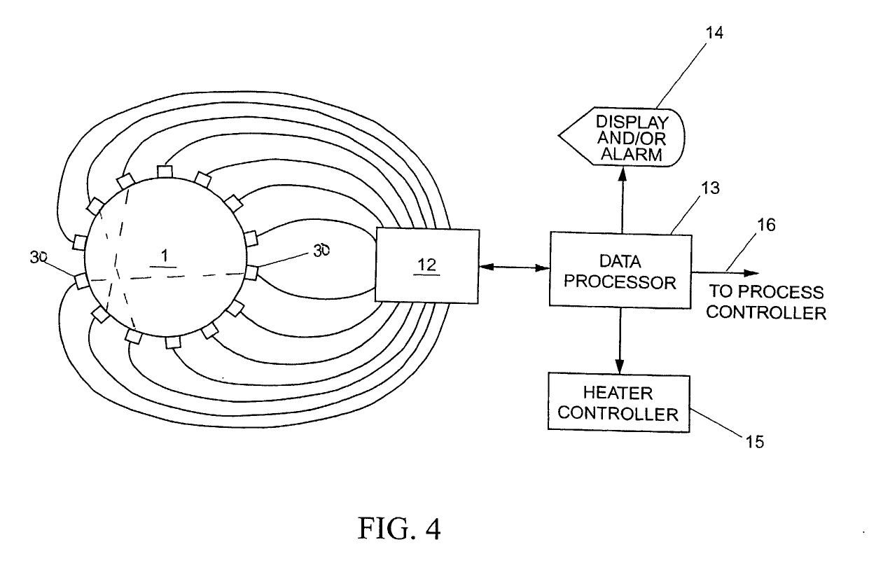

Of course, the invention can be practiced with a variety of implementations and architectures, including those in which the functions of determining propagation time, determining velocity, determining temperature, and so forth, are performed by different elements than those described above. In one such alternate embodiment, illustrated in FIG. 4, the transducers 3 of FIG. 1 are replaced with sensors 30 that measure a signal transmitted across the substrate holder. In one embodiment, the sensors 30 measure resistance between sensors and utilize a relation of resisitvity of a material to temperature. Accordingly, temperature can be measured indirectly using resistances between sensors. The signal may either be transmitted across a solid layer coupling sensors or may be transmitted using individual “strands”, wires or strips of conductive material (e.g., aluminum) that connect sensors. Accordingly, while the remainder of the specification describes techniques using transducers 3, it should be understood that the techniques are equally applicable to other sensors such as sensors 30 discussed above.

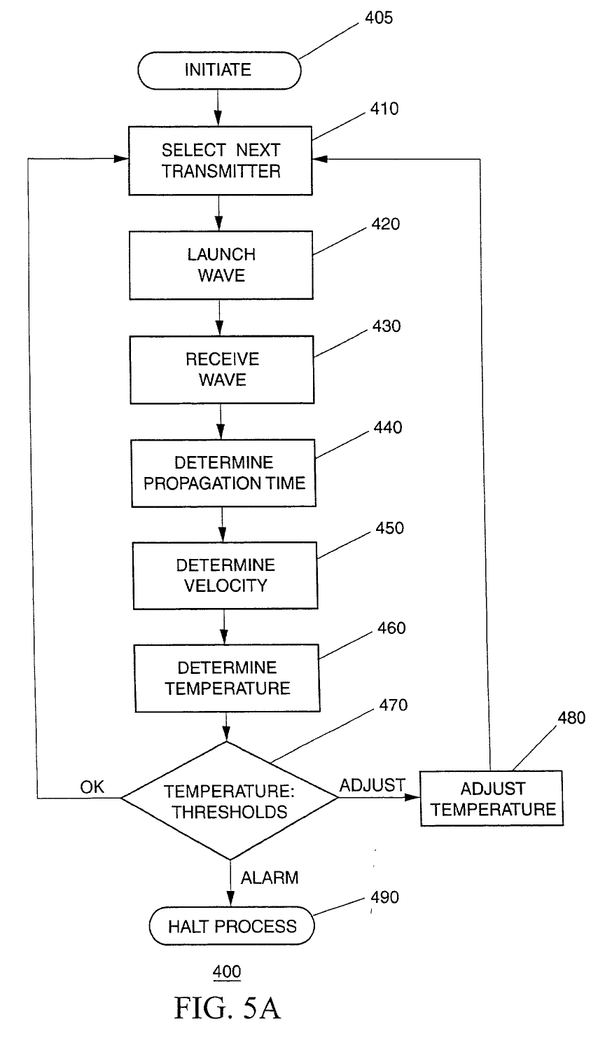

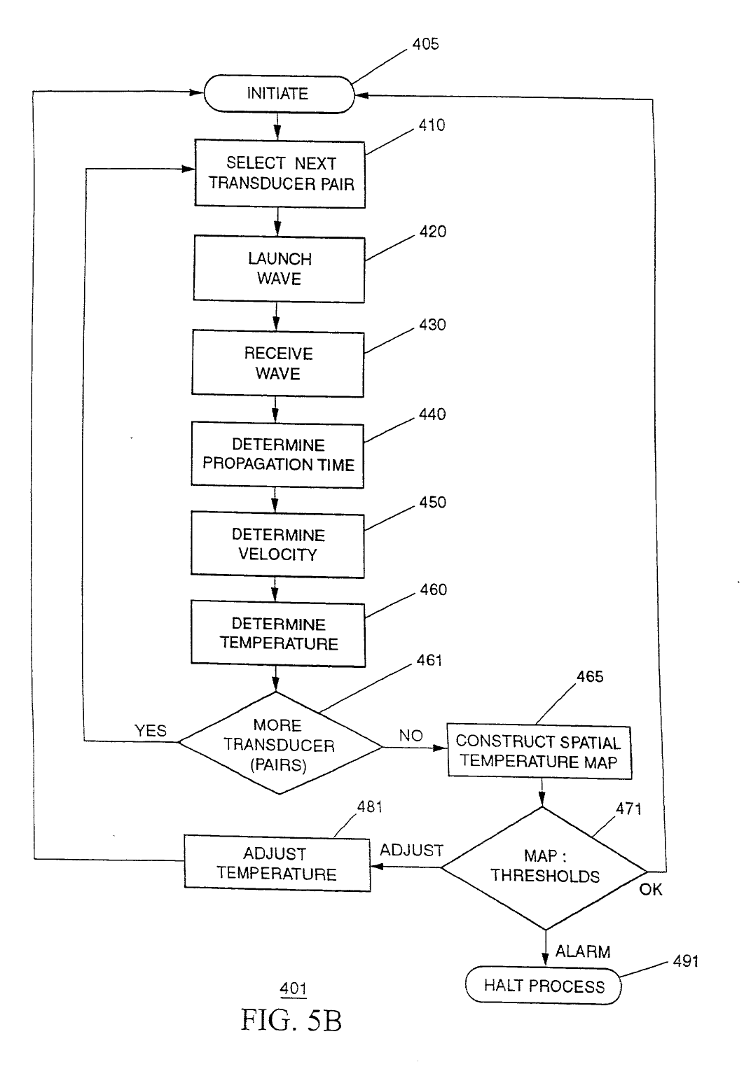

FIG. 5A is a flow chart illustrating a substrate holder temperature sensing and control method according to one embodiment of the present invention.

Step 405 indicates commencement of method 400, and step 410 indicates selection of a transducer from the set of transducers 3 to be used as a transmitter. In embodiments in which only a single transducer is used to both transmit and receive, this step indicates selection of that single transducer, but illustratively, only the embodiment using pairs of transducers is used as the basis of the following discussion. In any event, step 410 is similar to the “increment counter” step in a loop, and determines the transducer pair that is the subject of the steps in the loop that follows.

Step 420 indicates launching of the ultrasonic energy by the transducer that was selected as the transmitter during a transmit time.

Step 430 indicates the reception of ultrasonic energy by one of transducers 3 during a receive time that is later than the transmit time. The propagation time is determined by the architecture of the substrate holder and the particular “slice” (portion) of the substrate holder through which the ultrasonic energy has been transmitted. This step can include a filtering out of ultrasonic energy that arrives outside a “window” of arrival times, so that undesirable echoes from other parts of the substrate holder do not interfere with the desired signal peak. During the filtering process, the received signal can be analyzed to assure that those components, such as cooling ducts, etc., that lie within the transmission path of the ultrasonic wave are functioning properly, i.e. coolant is or is not flowing through the cooling channels. The above determination can be made by comparing the form of the received signal to a typical transmission signature when all components are functioning as expected.

Transducer controller 12 can transmit and receive signals using a single transducer by controlling the transducer to operate as a transmitter during a transmit period of time and to operate as a receiver during a receive period of time. Transducer controller 12 can transmit using a single transducer by controlling the transducer to operate as a transmitter during a transmit period of time and can receive signals from at least one other transducer by controlling the at least one other transducer to operate in a receive mode during receive periods of time. Transducer controller 12 can transmit using a number of transducers by controlling the number of transducers to operate as transmitters during transmit periods of time and can receive signals from at least one other transducer by controlling the at least one other transducer to operate in a receive mode during receive periods of time.

In step 440 the propagation time is determined. In the illustrated embodiment, the calculation of the propagation time is based on a subtraction of the launching time from the reception time. Alternatively, the propagation time can be calculated using multiple launch times and/or multiple reception times. In the exemplary embodiment shown in FIG. 1B, the determination of propagation time is performed by transducer controller 12. Alternately, the determination of propagation time can be performed by the data processor.

In step 450, the velocity of the ultrasonic energy is determined. For example, the formula (velocity=distance/time) can be used. In the exemplary embodiment of FIG. 1B, the velocity of the ultrasonic wave in the substrate holder is determined by data processor 13. In a preferred embodiment, the propagation distance between each selectable pair of transducers is determined for the substrate holder, and this data is stored in data processor 13. In step 460, the temperature is determined. For example, data processor uses at least one velocity versus temperature curve such as the curve shown in FIG. 3 to determine the temperature of that portion of the substrate holder that corresponds to the slice through which the ultrasonic energy traveled. In a preferred embodiment, the velocity versus temperature curves for the propagation paths between each selectable pair of transducers are determined for the substrate holder, and this data is stored in data processor 13. The step 470, a query is performed to determine whether or not the computed temperature is within predetermined parameters.

If the computed temperature is within allowed parameters, then control returns to step 410 for selection of the next transducer pair, and method 400 continues as shown in FIG. 5A.

If step 470 determines that there is a moderate temperature variation that does not require halting of the process, control passes to block 480. In step 480, the temperature of the substrate holder is adjusted. For example, data processor 13 can send a message to heater controller 15 indicating that it should correct the temperature in the portion of the substrate holder that corresponds to the portion through which the ultrasonic energy traveled.

If step 470 determines that an extreme temperature limit was exceeded, control passes to block 490 in which the process is halted. For example, data processor 13 can send a message indicating that the process should be halted altogether, either by a message on FIG. 1B path 16 to the process controller or by an alarm message sent to display and/or alarm unit 14.

It will be appreciated that FIG. 5A proceeds on a slice-by-slice basis, with each temperature measurement being used to govern temperature control in discrete “slices.” In contrast, the embodiment of an alternate method that employs tomographic techniques in a more holistic approach to temperature sensing and control is shown in FIG. 5B.

FIG. 5B's blocks 400 through 460 correspond to like-numbered blocks in FIG. 5A, and discussion thereof need not be repeated.

However, after block 460 determines a temperature for a selected transducer pair, decision block 461 determines whether there are any more transducer pairs to process. If there are more transducer pairs to process, control returns to block 410 in which a next transducer pair is selected for processing. An exemplary set of transducer pairs can include pairs wherein a transmitting transducer is selected from the plurality of transducers 3 and the receiving transducer is multi-plexed through all of the transducers in contact with substrate holder 1. This process can be repeated where each transducer is selected as the transmitting transducer. When all the transducer pairs have been processed, control passes to block 465, which indicates data processor 13's construction of a spatial temperature map of the substrate holder in accordance with a suitable tomographic technique. Alternately, multiple transducers can be selected during a particular receive time.

Decision block 471 indicates the data processor's decision of whether the spatial temperature map lies within allowed parameters. For example, the variance or rootmean-square of spatial deviations of the measured temperature map from the expected temperature map (determined empirically and stored in a look-up table) can be computed and employed for the above decision.

If data processor 13 determines that the spatial temperature map lies within allowed parameters, control returns to block 405 where method 401 continues as shown in FIG. 5B.

If data processor 13 determines that the map deviates moderately from ideal but does not require halting of the etching process, control passes to block 481. In block 481 the temperature is adjusted. For example, data processor 13 can send a message to heater controller 15 indicating that it should correct the temperature throughout the portions of the substrate holder that caused the deviation from ideal temperature.

If data processor 13 determines that an extreme deviation from the ideal temperature map has occurred, control passes to block 491 in which method 401 ends. For example, data processor 13 can send a message indicating that the process should be halted altogether, either by a message on FIG. 1B path 16 to the process controller or by an alarm message sent to display and/or alarm unit 14.

Those skilled in the art will appreciate that FIG. 5B adopts a more holistic approach than FIG. 5A, in that the method of FIG. 5B controls a substrate holder temperature profile across the entire substrate holder rather than discretely on a slice-by-slice basis.

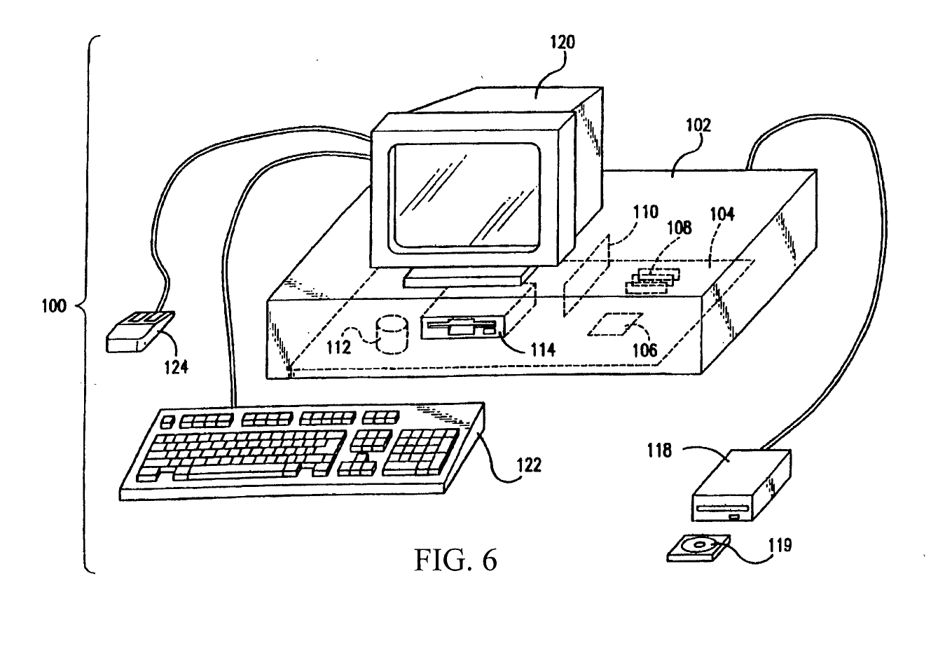

FIG. 6 is a schematic illustration of a computer system for tracking temperature and tomographic information. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of tracked temperatures and tomographic information.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for tracking temperature and tomographic information. The computer code devices of the present invention can be any interpreted or executable code mechanism, including but not limited to scripts, interpreters, dynamic link libraries, Java classes, and complete executable programs.

Modifications and variations of the above-described embodiments of the present invention are possible, as appreciated by those skilled in the art in light of the above teachings. For example, the number, arrangement, and composition of the transducers may be varied while remaining within the scope of the present invention. Further, the invention contemplates that a wide variety of implementations of hardware architecture and software processing techniques may be employed to achieve the functions and advantages described herein. It is therefore to be understood that, within the scope of the appended claims and their equivalents, the invention may be practiced otherwise than as specifically described.

1. An apparatus for measuring temperatures of respective portions of a substrate holder that supports a substrate on which a process is carried out, the apparatus comprising:
at least one ultrasonic transducer arranged and configured to transmit ultrasonic energy through the respective portions of the substrate holder; and
a data processor configured to calculate, during the process, the temperatures of the respective portions of the substrate holder based on respective propagation time delays of the ultrasonic energy through the respective portions.

2. The apparatus of claim 1, wherein:
the data processor is further configured to calculate velocities of the ultrasonic energy based on the propagation time delays; and
the data processor is further configured to calculate the temperatures based on the respective calculated velocities and a known relationship of temperature versus ultrasonic wave velocity in the respective portions of the substrate holder.

3. The apparatus of claim 1, wherein the data processor is further configured to use tomographic techniques to construct a temperature map of the substrate holder based collectively on the calculated temperatures of the respective portions of the substrate holder.

4. The apparatus of claim 1, wherein the substrate holder comprises an electrostatic chuck.

5. A method of measuring temperatures of respective portions of a substrate holder that supports a substrate on which a process is carried out, the method comprising:
transmitting ultrasonic energy through the respective portions of the substrate holder using an arrangement of at least one ultrasonic transducer; and
calculating, during the process, the temperatures of the respective portions of the substrate holder based on respective propagation time delays of the ultrasonic energy through the respective portions.

6. The method of claim 4, wherein the calculating step includes:
calculating velocities of the ultrasonic energy based on the propagation time delays; and
calculating the temperatures based on the respective calculated velocities and a known relationship of temperature versus ultrasonic wave velocity in the substrate holder.

7. The method of claim 5, further comprising using tomographic techniques to construct a temperature map of the substrate holder based collectively on the calculated temperatures of the respective portions of the substrate holder.

8. The method of claim 5, wherein the substrate holder comprises an electrostatic chuck.

9. An apparatus for measuring temperatures of respective portions of a substrate holder that supports a substrate on which a process is carried out, and for controlling the temperatures of the respective portions in response to the measured temperatures, the apparatus comprising:
at least one ultrasonic transducer arranged and configured to transmit ultrasonic energy through the respective portions of the substrate holder; and
a data processor configured to calculate, during the process, the temperatures of the respective portions of the substrate holder based on respective propagation time delays of the ultrasonic energy through the respective portions;
wherein the data processor is further configured to communicate, during the process, at least one of (1) a correction signal to a heater controller, (2) a warning signal to a display/alarm device and (3) an error signal to a process controller, if a calculated temperature exceeds a predetermined temperature limit.

10. The apparatus of claim 9, wherein:
the data processor is further configured to calculate velocities of the ultrasonic energy based on the propagation time delays; and
the data processor is further configured to calculate the temperatures based on the respective calculated velocities and a known relationship of temperature versus ultrasonic wave velocity in the substrate holder.

11. The apparatus of claim 9, wherein the data processor is further configured to use tomographic techniques to construct a temperature map of the substrate holder based collectively on the calculated temperatures of the respective portions of the substrate holder.

12. The apparatus of claim 11, wherein the substrate holder comprises an electrostatic chuck.

13. A method of measuring temperatures of respective portions of a substrate holder that supports a substrate on which a process is carried out, and for controlling the temperatures of the respective portions in response to the measured temperatures, the method comprising:
transmitting ultrasonic energy through the substrate holder using an arrangement of at least one ultrasonic transducer;
calculating, during the process, the temperatures of the respective portions of the substrate holder based on respective propagation time delays of the ultrasonic energy through the respective portions; and
communicating, during the process, at least one of (1) a correction signal to a heater controller, (2) a warning signal to a display/alarm device and (3) an error signal to a process controller, if a calculated temperature exceeds a predetermined temperature limit.

14. The method of claim 13, wherein the temperature calculating step includes:
calculating velocities of the ultrasonic energy based on the propagation time delays; and
calculating the temperatures based on the respective calculated velocities and a known relationship of temperature versus ultrasonic wave velocity in the substrate holder.

15. The method of claim 13, further comprising using tomographic techniques to construct a temperature map of the substrate holder based collectively on the calculated temperatures of the respective portions of the substrate holder.

16. The method of claim 15, wherein the substrate holder comprises an electrostatic chuck.

17. A method of measuring respective portions of a substrate holder that supports a substrate on which a process is carried out to ensure that respective elements within the substrate holder are operating correctly, the method comprising:
transmitting ultrasonic energy through the substrate holder using an arrangement of at least one ultrasonic transducer;
calculating, during the process, the respective propagation time delays of the ultrasonic energy through the respective portions; and
communicating, during the process, at least one of (1) an error signal to a process controller and (2) a warning signal to a display/alarm device, if a calculated propagation time delay exceeds a predetermined limit.

18. The method of claim 17, wherein the substrate holder comprises an electrostatic chuck.

19. An apparatus for measuring temperatures of respective portions of a substrate holder that supports a substrate on which a process is carried out, the apparatus comprising:
at least one sensor arranged and configured to receive a signal transmitted through the respective portions of the substrate holder; and
a data processor configured to calculate, during the process, the temperatures of the respective portions of the substrate holder based on respective signals received by the at least one sensor.

20. The apparatus of claim 19, wherein:
the data processor is further configured to calculate resistances based on the signals received by the at least one sensor; and
the data processor is further configured to calculate the temperatures based on the respective resistances in the respective portions of the substrate holder.

21. The apparatus of claim 19, wherein the data processor is further configured to use tomographic techniques to construct a temperature map of the substrate holder based collectively on the calculated temperatures of the portions of the substrate holder.

22. The apparatus of claim 19, wherein the substrate holder comprises an electrostatic chuck.

23. A method of measuring temperatures of respective portions of a substrate holder that supports a substrate on which a process is carried out, the method comprising:
receiving a signal, transmitted through the respective portions of the substrate holder, using at least one sensor; and
calculating, during the process, the temperatures of the respective portions of the substrate holder based on respective signals received by the at least one sensor.

24. The method of claim 23, wherein the calculating step comprises:
calculating resistances of the substrate holder based on the signals received by the at least one sensor; and
calculating the temperatures of the respective portions based on the respective resistances in the substrate holder.

25. The method of claim 23, further comprising:
using tomographic techniques to construct a temperature map of the substrate holder based collectively on the calculated temperatures of the respective portions of the substrate holder.

26. The method of claim 23, wherein the substrate holder comprises an electrostatic chuck.

27. An apparatus for measuring temperatures of respective portions of a substrate holder that supports a substrate on which a process is carried out, and for controlling the temperatures of the respective portions in response to the measured temperatures, the apparatus comprising:
at least one sensor arranged and configured to receive a signal transmitted through the respective portions of the substrate holder; and
a data processor configured to calculate, during the process, the temperatures of the respective portions of the substrate holder based on respective signals transmitted through the respective portions of the substrate holder;
wherein the data processor is further configured to communicate, during the process, at least one of (1) a correction signal to a heater controller, (2) a warning signal to a display/alarm device and (3) an error signal to a process controller, if a calculated temperature exceeds a predetermined temperature limit.

28. The apparatus of claim 27, wherein:
the data processor is further configured to calculate resistances based on the signals received by the at least one sensor; and
the data processor is further configured to calculate the temperatures based on the respective resistances in the substrate holder.

29. The apparatus of claim 27, wherein the data processor is further configured to use tomographic techniques to construct a temperature map of the substrate holder based collectively on the calculated temperatures of the respective portions of the substrate holder.

30. The apparatus of claim 29, wherein the substrate holder comprises an electrostatic chuck.

31. A method of measuring temperatures of respective portions of a substrate holder that supports a substrate on which a process is carried out, and for controlling the temperatures of the respective portions in response to the measured temperatures, the method comprising:
receiving a signal, transmitted through the substrate holder, using at least one sensor;
calculating, during the process, the temperatures of the respective portions of the substrate holder based on respective signals transmitted through the respective portions; and
communicating, during the process, at least one of (1) a correction signal to a heater controller, (2) a warning signal to a display/alarm device and (3) an error signal to a process controller, if a calculated temperature exceeds a predetermined temperature limit.

32. The method of claim 31, wherein the temperature calculating step comprises:
calculating resistances based on the signals received by the at least one sensor; and
calculating the temperatures based on the respective resistances in the substrate holder.

33. The method of claim 31, further comprising:
using tomographic techniques to construct a temperature map of the substrate holder based collectively on the calculated temperatures of the portions of the substrate holder.

34. The method of claim 33, wherein the substrate holder comprises an electrostatic chuck.

35. A method of measuring respective portions of a substrate holder that supports a substrate on which a process is carried out to ensure that respective elements within the substrate holder are operating correctly, the method comprising:
receiving a signal, transmitted through the substrate holder, using at least one sensor;
calculating, during the process, the temperatures of the respective portions of the substrate holder based on the respective signals transmitted through the respective portions; and
communicating, during the process, at least one of (1) an error signal to a process controller and (2) a warning signal to a display/alarm device, if a calculated temperature exceeds a predetermined limit.

36. The method of claim 35, wherein the substrate holder comprises an electrostatic chuck.
